(19) United States
(12) Patent Application Publication
(10) Pub. No.: US 2007/0242277 A1
(43) Pub. Date: Oct. 18, 2007

(54) Optical navigation in relation to transparent objects

(76) Inventors: David W. Dolfi, Los Altos, CA (US); Annette C. Grot, Cupertino, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/403,720

(22) Filed: Apr. 13, 2006

(51) Int. Cl. G01B 11/02

(52) U.S. Cl. 356/498

(57) ABSTRACT

An optical navigation system includes an illumination system, an image sensor, and a processing system. The illumination system directs a beam of output light toward an object so that a first portion of the output light beam reflects off the object front surface to form a first reflected light beam and a second portion of the output light beam reflects off the object back surface to form a second reflected light beam, where the first and second reflected light beams overlap in a region of space to produce an interference pattern. The image sensor captures images of the interference pattern. The processing system produces motion signals indicative of movement of the image sensor in relation to the object from comparisons of ones of the images captured by the image sensor.

### BACKGROUND

Many different types of input devices have been developed for inputting commands into a machine. For example, hand-manipulated input devices, such as computer mice, joysticks, trackballs, touchpads, and keyboards, commonly are used to input instructions into a computer by manipulating the input device. Such input devices allow a user to control movement of a virtual pointer, such as a cursor, across a computer screen, select or move an icon or other virtual object displayed on the computer screen, and open and close menu items corresponding to different input commands. Input devices commonly are used in both desktop computer systems and portable computing systems.

Input devices typically include a mechanism for converting a user input into user interface control signals, such as cursor position data and scrolling is position and distance data. Although some types of input device use electromechanical transducers to convert user manipulation of the input device into user interface control signals, most recently developed input devices use optical navigation sensors to convert user manipulation of the input device into user interface control signals. The optical navigation sensors employ optical navigation technology that measures changes in position by acquiring a sequence of images of light reflecting from a surface and mathematically determining the direction and magnitude of movement over the surface from comparisons of corresponding features in the images. Such optical navigation systems typically track the scanned path of the input device based on detected pixel-to-pixel surface reflectivity differences that are captured in the images. These changes in reflectivity may be quite small depending upon the surface medium (e.g., on the order of 6% for white paper).

One problem with existing optical navigation sensors is that they are unable to navigate well on very smooth surfaces, such as glass, because the images reflected from such surfaces are insufficiently different to enable the direction and magnitude of movement over the surface to be determined reliably. In an attempt to solve this problem, optical navigation sensors have been proposed that illuminate smooth-surfaced objects with coherent light. The objects induce phase patterns in the illuminating light that are correlated with optical nonuniformities in or on the objects. Optical navigation sensors of this type include an interferometer that converts the phase patterns into interference patterns (or interferograms) that are used to determine relative movement with respect to the objects. Although this approach improves navigation performance over specular surfaces, uniform surfaces, and surfaces with shallow features, this approach relies on optical nonuniformities, such as scratches, imperfections, and particulate matter in or on the surface to produce the phase patterns that are converted into the interferograms by the component interferometers. As a result, this approach is unable to navigate reliably over surfaces that are free of such specular features.

What are needed are systems and methods of navigating optically over smooth surfaces and surfaces that are substantially transparent to the illuminating is light in a manner that does not rely on the presence of specular optical nonuniformities in or on the surfaces.

### SUMMARY

In one aspect, the invention features an optical navigation system for determining movement in relation to an object that has a front surface and a back surface and is substantially transparent to light within a wavelength range. In accordance with this aspect of the invention, the optical navigation system includes an illumination system, an image sensor, and a processing system. The illumination system directs a beam of output light within the wavelength range toward the object so that a first portion of the output light beam reflects off the front surface to form a first reflected light beam and a second portion of the output light beam, reflects off the back surface to form a second reflected light beam, wherein the first and second reflected light beams overlap in a region of space to produce an interference pattern. The image sensor captures images of the interference beam. The processing system produces motion signals indicative of movement of the image sensor in relation to the object from comparisons of ones of the images captured by the image sensor.

In another aspect, the invention features an optical navigation method in accordance with which a beam of output light within the wavelength range is directed toward the object. A first portion of the output light beam is reflected off the front surface to form a first reflected light beam. A second portion of the output light beam passing through the object is reflected off the back surface to form a second reflected light beam passing out the front surface. The first and second reflected light beams are overlapped to produce an interference pattern. Images of the interference pattern are captured. Motion signals indicative of movement in relation to the object are produced from comparisons of ones of the images captured by the image sensor.

Other features and advantages of the invention will become apparent from the following description, including the drawings and the claims.

### DESCRIPTION OF DRAWINGS

FIG. 1 is a diagrammatic view of an embodiment of an optical navigation system and an object that is transparent to light within a wavelength range.

FIG. 2 is a flow diagram of an embodiment of a method of optically navigating with respect to transparent objects.

FIG. 3A is a diagrammatic view of a beam of output light produced by the optical navigation system shown in FIG. 1 and illuminating a front surface of the transparent object, and a first portion of the beam of output light reflecting off the front surface.

FIG. 3B is a diagrammatic view of a second portion of the beam of output light shown in FIG. 3A traveling through the transparent object, reflecting off the back surface of the transparent object, and traveling back through the transparent object and out the front surface.

FIG. 3C is a diagrammatic view of the first and second portions of the beam of output light shown in FIGS. 3A and 3B overlapping in a region of space to produce an interference beam that includes an interference pattern.

FIG. 4 is a block diagram of an embodiment of the optical navigation system shown in FIG. 1.

FIG. 5 is a block diagram of an embodiment of the optical navigation system shown in FIG. 1.

FIG. 6 is a block diagram of an embodiment of the optical navigation system shown in FIG. 1.

FIGS. 7A and 7B are block diagrams of an embodiment of the optical navigation system shown in FIG. 1 illuminating respective transparent objects characterized by different thicknesses.

FIG. 8 is a perspective view of a housing containing an embodiment of the optical navigation system shown in FIG. 1.

FIG. 9 is a perspective view of the housing shown in FIG. 8 with a top portion of the housing removed to reveal components of the optical navigation system.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

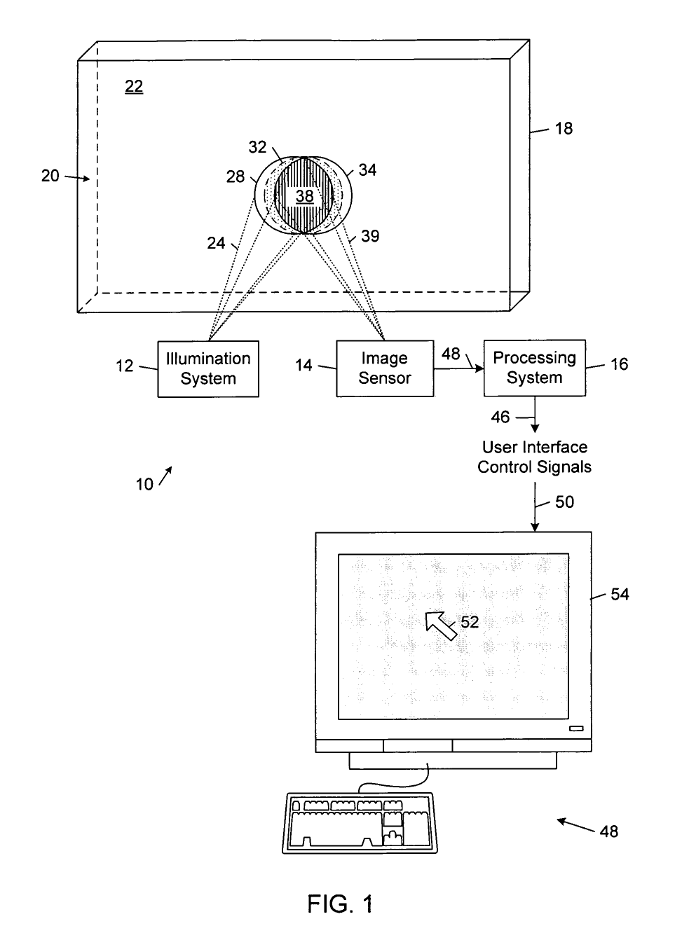

FIG. 1 shows an embodiment of an optical navigation sensor 10 that includes an illumination system 12, an image sensor 14, and a processing system 16. In general, the optical navigation sensor 10 may be incorporated into any type of device or system in which sensing relative motion serves a useful purpose. For illustrative purposes, the optical navigation sensor 10 is described herein as a component of a device for inputting commands into a machine, where the input device may have any of a wide variety of different form factors, including a computer mouse, a joystick, a trackball, and a steering wheel controller. In these implementations, the optical navigation sensor 10 may be configured to optically sense user manipulations of a component of the input device (e.g., a touch pad, a trackball, or a joystick) or manipulations of the input device itself (e.g., movement of the input device across a surface or through the air).

As explained in detail below, the optical navigation sensor 10 is able to navigate optically over transparent objects in a manner that does not rely on the presence of specular optical nonuniformities in or on the object. Thus, in addition to being able to navigate over specular surfaces and smooth surfaces containing optical nonuniformities, these embodiments are able to navigate optically over smooth surfaces of transparent objects that are free of specular nonuniformities. For illustrative purposes, the operation of the optical navigation sensor 10 is described herein with respect to an object 18, which has smooth front and back surfaces 20, 22 and is transparent to light with a wavelength range, which typically is within the visible light spectrum or within the infrared light spectrum.

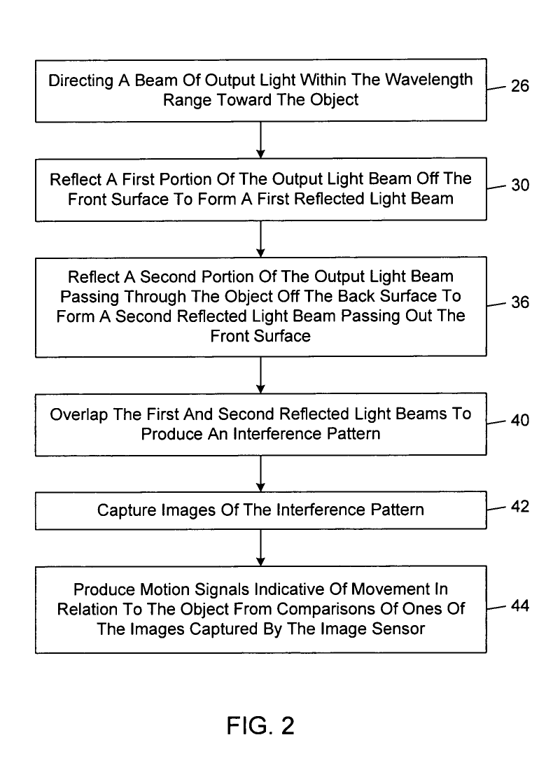

FIG. 2 shows a flow diagram of an embodiment of a method that is implemented by the optical navigation sensor 10 shown in FIG. 1. In accordance with this method, the illumination system 12 directs a beam 24 of output light within the wavelength range toward the object 18 (FIG. 2, block 18). The illumination system 12 includes a light source that generates the output light beam 24. Exemplary light sources include light emitting diodes, single-mode lasers, and multimode lasers. The illumination system 12 also may include one or more optical elements for directing (e.g., shaping, focusing, or changing the propagation path on the output light beam 24 to an illumination area 28 of the front surface 20 of the object 18.

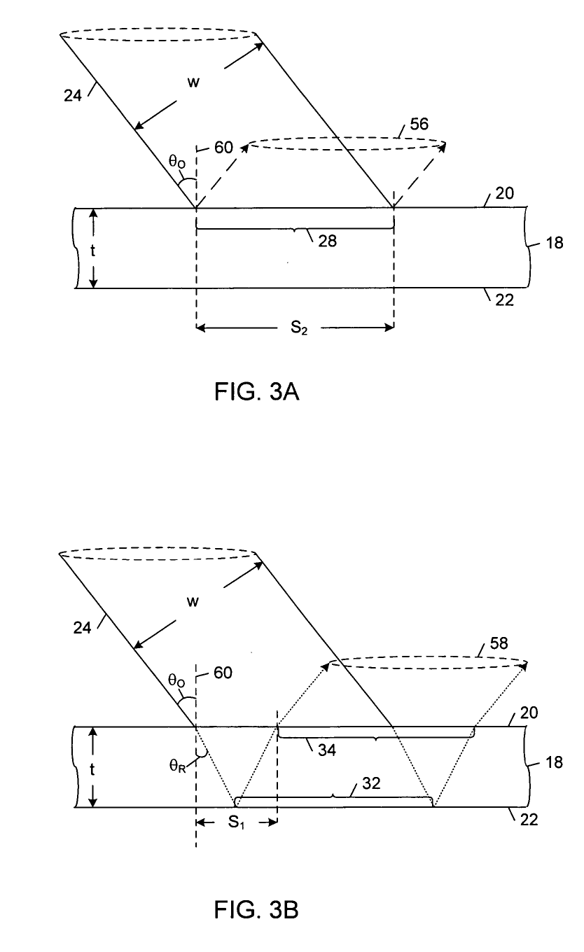

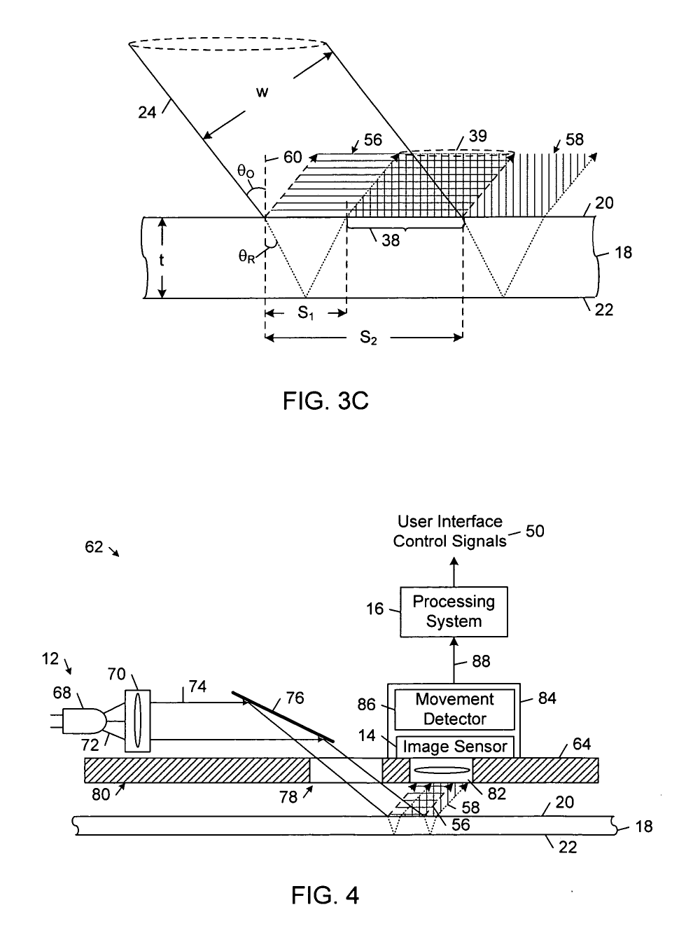

As explained in detail below in connection with FIGS. 3A-3C, a first portion of the output light beam 24 reflects off the front surface 20 of the object 18 to form a first reflected light beam (FIG. 2, block 30). A second portion of the output light beam 24 travels through the object 18 to an illumination area 32 on the back surface 22, where it reflects off the back surface 22 and travels back through the object 18 and out the front surface 20 in an exit area 34 to form of a second reflected beam (FIG. 2, block 36). The first and second reflected beams overlap in a region of space 38 to produce an interference beam 39 that includes an interference pattern, which is shown diagrammatically in FIG. 1 as a series of parallel vertical lines (FIG. 2, block 40).

Referring to FIGS. 1 and 2, the image sensor 14 captures images of the interference beam 39 (FIG. 2, block 42). The image sensor 14 includes an optical detector that is capable of detecting light within the wavelength range. In general, the image sensor 14 may include one or more photodetector devices, including a one-dimensional optical detector (e.g., a linear array of photodiodes) and a two-dimensional optical detector (e.g., a CCD or CMOS image sensor device). The image sensor 14 also may include one or more optical elements for directing (e.g., shaping, focusing, or changing the propagation path of) the interference beam 39 to the optical detector.

Depending on the implementation, either the image sensor 14 or the processing system 16 produces motion signals indicative of movement of the image sensor 14 in relation to the object 18 from comparisons of ones of the images captured by the image sensor 14 (FIG. 2, block 44). In the illustrated embodiment, the processing system 16 produces user interface control signals 46 from the electrical signals 48 that are output from the image sensor 14. Examples of the types of user interface control signals that may be produced by the processing system 16 include cursor position and movement data and scrolling position and distance data. The user interface control signals 46 are transmitted to a computer 48 over a communication link 50 (e.g., a serial communication link, such as an RS-232 serial port, a universal serial bus, or a PS/2 port). In operation, the computer 48 executes a driver in an operating system or an application program that processes the first and second user interface control signals to control the display and movement of a pointer 52 on a computer monitor 54.

The processing system 16 may be implemented by one or more discrete 20 modules that are not limited to any particular hardware or software configuration.

The one or more modules may be implemented in any computing or processing environment, including in digital electronic circuitry (e.g., an application-specific integrated circuit, such as a digital signal processor (DSP)) or in computer hardware, firmware, device driver, or software.

As explained above with reference to FIG. 1, the illumination system 12 directs the output light beam 24 toward the object 18 in a way that produces the interference beam 39. FIGS. 3A-3C diagrammatically show the process by which the interference beam 39 may be produced. Referring to FIG. 3A, a first portion of the output light beam 24 reflects off the front surface 20 of the object 18 to form a first reflected light beam 56. Referring to FIG. 3B, a second portion of the output light beam 24 travels through the object 18 to the illumination area 32 on the back surface 22, where it reflects off the back surface 22 and travels back through the object 18 and out the front surface 20 in the exit area 34 to form of a second reflected beam 58. As shown in FIG. 3C, the first and second reflected beams 56, 58 overlap in the region of space 38 to produce the interference beam 39.

Variations in the thickness between the front and back surface 20, 22 produce variations in the interference patterns that are imaged by the optical navigation sensor 10. The optical navigation sensor 10 tracks its relative movement in relation to the object 18 based on differences between the captured images of the interference patterns.

In general, for the interference beam 39 to be produced, at least portions of the first and second reflected beams 56, 58 must overlap in the capture plane of the image sensor 14. In the illustrative example shown in FIGS. 3A-3C, this condition translates into the requirement that the lateral width S₂ of the first and second reflected beams 56, 58 in a plane parallel to the front and back surfaces 20, 22 of the object 18 must be less than the lateral shift S₁ of the exit area 34 in relation to the illumination area 28 on the front surface 20 of the object 18. The parameter S₁ is given by:
S₁=2·t·tanθ_{R} (1)
where t is the thickness of the object 18 in a direction 60 normal to the front and back surfaces 20, 22 and θ_{R} is the entry angle of the second portion of the output light beam 24 in relation to the normal direction 60. The entry angle θ_{R} is given by:

$${θ}_{R} = {sin}^{- 1} ( \frac{sin {θ}_{O}}{n} ) \qquad ( 2 )$$

where θ_{O} is the incidence angle of the output light beam 24 in relation to the normal direction 60 and n is the index of refraction of the object 18. The parameter S₂ is given by:

$${S}_{2} = \frac{w}{cos {θ}_{O}} \qquad ( 3 )$$

where w is the transverse width of the output light beam 24. The condition S₁<S₂ implies that:

$$\frac{t}{w} < \frac{cos {θ}_{R}}{2 \cdot sin {θ}_{R} cos {θ}_{O}} \qquad ( 4 )$$

In accordance with the condition defined in equation (4), the transverse width w and the incidence angle θ_{O} of the output light beam 24 must be tailored to accommodate the thickness t and the refractive index n of the object 18 in order to produce the interference beam 39. In some embodiments, the transverse width w and the incidence angle θ_{O} of the output light beam 24 are preconfigured to a particular type of object having a specified thickness and a specified refractive index (e.g., a sheet of float glass having a thickness of 6.4 millimeters and a refractive index of 1.5). In other embodiments, the optical navigation sensor 10 produces the output light beam 34 with multiple transverse widths wᵢ and/or incidence angles θ_{O,j}, wherein at least one combination of these parameter values satisfies equation (4) with respect to the thickness t and the refractive index n of the object 18.

FIG. 4 shows an embodiment 62 of the optical navigation sensor 10 that includes the illumination system 12, the image sensor 14, the processing system 16, and a bottom part 64 of a housing (only partially shown in FIG. 4).

In the illustrated embodiment, the illumination system 12 is implemented by a laser 68 and an optical element 70 that collimates the light 72 that is produced by the laser 68 into a collimated output light beam 74. An optical element 76 (e.g., a mirror) deflects the collimated output light beam 76 through an optical port 78 defined in the bottom part 64 of the housing. In the illustrated example, the optical port 78 is defined in a registration surface 80, which ifaces the front surface 20 of the object 18 in a navigation mode of operation. The illumination system 12 is oriented to direct the output light beam 74 toward the object 18 to produce the interference beam 39 when the registration surface 80 of the housing is facing the front surface 20 of the object 18.

In the embodiment shown in FIG. 4, the image sensor 14 is incorporated in a navigation sensor module 84 that also includes a movement detector 86. The image sensor 14 may be any type of image forming device that is capable of capturing one-dimensional or two-dimensional images of the interference beam 39 that is produced in the region 38 where the first and second reflected beams 56, 58 overlap. The image sensor 14 includes at least one photosensor element. Exemplary image sensors include CMOS (Complimentary Metal-Oxide Semiconductor) and CCD (Charge-Coupled Device) image sensors that have one-dimensional and two-dimensional arrays of photosensor elements. The image sensor 14 captures images at a rate (e.g., 1500 pictures or frames per second) that is fast enough so that sequential pictures of the interference beam 39 overlap. The navigation sensor module 84 may include one or more optical elements that focus the interference beam 39 onto the one or more image sensors. In the embodiment shown in FIG. 4, the bottom part 64 of the housing includes an optical port 82 that receives the interference beam 39 from the front surface 20 of the object 18. The optical port 82 includes an optical element that focuses the interference beam 39 onto the active region (or capture plane) of the image sensor 14. In this embodiment, the received interference beam 39 travels from the optical port 82 to the image sensor 14 along a beam path that is free of any interferometric elements.

The movement detector 86 may be part of the processing system 16 or it may be part of the image sensor 14 as shown in FIG. 4. The movement detector 86 is not limited to any particular hardware or software configuration, but rather it may be implemented in any computing or processing environment, including in digital electronic circuitry or in computer hardware, firmware, or software. In one implementation, the movement detector 86 includes a digital signal processor (DSP).

With respect to transparent objects, the movement detector 86 detects relative movement between image sensor 14 and the object 18 based on comparisons between images of the interference beam 39 that are captured by the image sensor 14. In particular, the movement detector 86 identifies the interference patterns in the images and tracks the motion of the interference patterns across multiple images. The movement detector 86 identifies common features in sequential images and determines the direction and distance by which the identified common features are shifted or displaced.

With respect to opaque objects, the movement detector 86 identifies texture or other features in the images and tracks the motion of such features across multiple images. These features may be, for example, inherent to the surfaces of the opaque objects, relief patterns embossed on the surfaces of the opaque objects, or marking patterns printed on the surfaces of the opaque objects.

In some implementations, the movement detector 86 correlates features that are identified in successive images to provide information relating to the position of the object 18 relative to the image sensor 14. In general, any type of correlation method may be used to track the positions of the interference pattern across successive images. In some embodiments, a sum of squared differences correlation method is used to find the locations of identical interference pattern features in successive images in order to determine the displacements of the features across the images. In some of these embodiments, the displacements are summed or integrated over a number of images. The resulting integration values may be scaled to compensate for any image scaling by the optics associated with the navigation sensor module 84. The movement detector 86 translates the displacement information into two-dimensional relative motion vectors that describe the relative movement of the optical navigation sensor 62 in relation to the object 18. The processing system 16 produces the user interface control signals 50 from the two-dimensional motion vectors that are generated by the movement detector 86.

Additional details relating to the image processing and correlating methods that are performed by the movement detector 86 can be found in U.S. Pat. Nos. 5,578,813, 5,644,139, 5,703,353, 5,729,008, 5,769,384, 5,825,044, 5,900,625, 6,005,681, 6,037,643, 6,049,338, 6,249,360, 6,259,826, 6,233,368, and 6,927,758.

In some embodiments, the navigation sensor module 84 is implemented by an optical mouse navigation sensor module (e.g., the ADNS-2051 optical mouse navigation sensor available from Avago Technologies, Inc. of San Jose, Calif., U.S.A.).

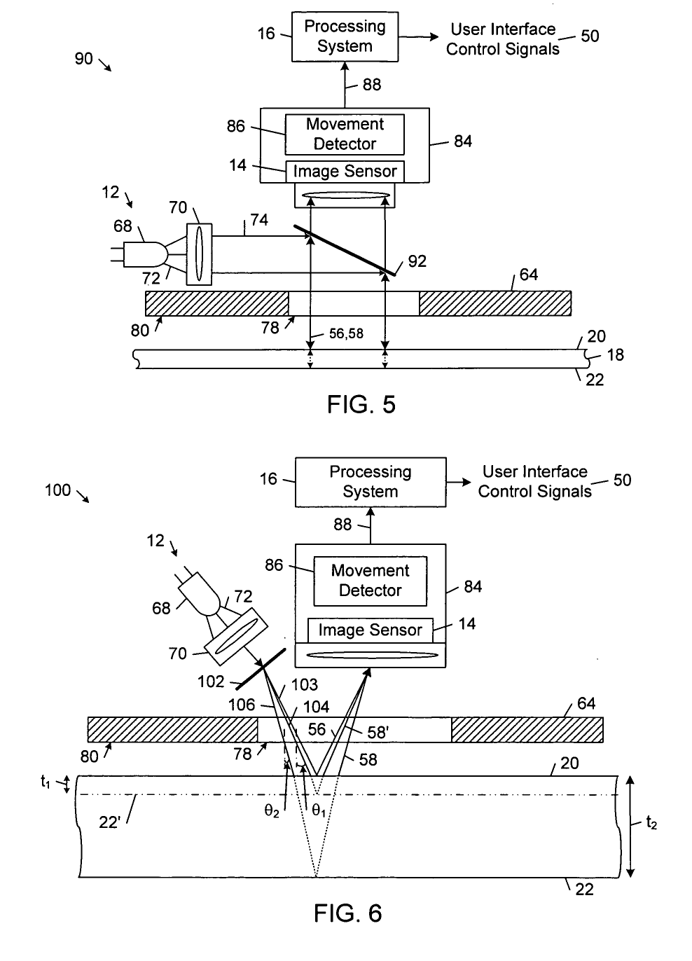

FIG. 5 shows a block diagram of an embodiment 90 of the optical navigation sensor 10. The optical navigation sensor 90 is similar to the embodiment 62 that is shown in FIG. 4, except that the optical element 76 is replaced by a beam splitter 92. In a typical mode of operating the optical navigation sensor 90, the beam splitter 92 directs the output light beam through the optical port 78 along a propagation direction normal to the registration surface 80, receives the interference beam 39 through the optical port 78, and passes at least a portion of the received interference beam 39 to the image sensor 14. The first and second reflected beams 56, 58 are substantially coincident when the registration surface 80 is substantially parallel to the front surface 20 of the object 18. In this embodiment, the received interference beam 39 travels from the optical port 78 to the image sensor 14 along a beam path that is free of any interferometric elements.

FIG. 6 shows a block diagram of an embodiment 100 of the optical navigation sensor 10. The optical navigation sensor 100 is similar to the embodiment 62 that is shown in FIG. 4, except that the optical element 76 is replaced by an optical component 102 that is operable to divide the collimated light beam 74 into a set of two or more output light beams 103, 104, and 106, which are output through the optical port 78 along different respective propagation directions in relation to the registration surface 80. In this way, the optical navigation sensor 100 is able to navigate optically with respect to transparent objects that have different thicknesses, such as a transparent object of thickness t₁, and a transparent object of thickness t₂>t₁, as shown in FIG. 6. In this example, the output light beam 103 reflects off the top surface 20 to produce the reflected light beam 56. The output light beam 104 is propagating at an incidence angle θ₁ in relation to a direction normal to the registration surface 80. This allows a portion of the output light beam 104 to reflect off the back surface 22′ at an angle that produces the reflected beam 58′, which produces an interference pattern with the reflected light beam 56 in the capture plane of the image sensor 14. The output light beam 106 is propagating at an incidence angle θ₂<θ₁ in relation to the direction normal to the registration surface 80. This allows a portion of the output light beam 106 to reflect off the back surface 22 at an angle that produces the reflected beam 58, which produces an interference pattern with the reflected light beam 56 in the capture plane of the image sensor 14.

The optical component 102 may be implemented by any light splitting device that is operable to direct the divided light beams along different respective propagation directions toward the object 18. In one exemplary embodiment, the optical component 102 is implemented by a diffractive optical element. In this embodiment, the received interference beam 39 travels from the optical port 78 to the image sensor 14 along a beam path that is free of any interferometric elements.

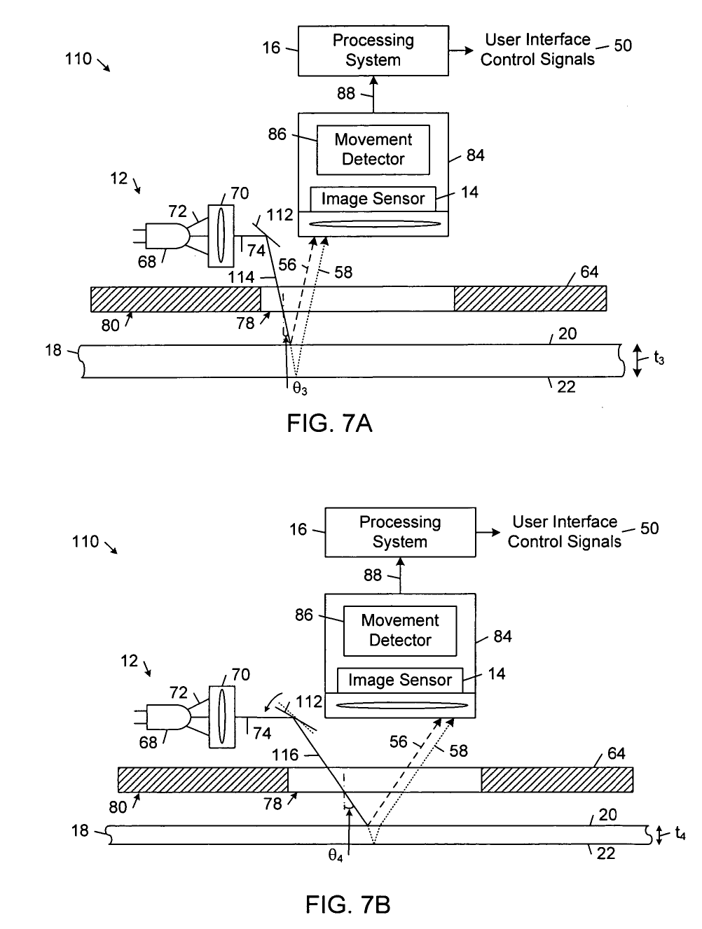

FIGS. 7A and 7B show a block diagram of an embodiment 110 of the optical navigation sensor 10. The optical navigation sensor 110 is similar to the embodiment 62 that is shown in FIG. 4, except that the optical element 76 is replaced by an actuatable optical element 112 that is operable to direct the collimated light beam 74 through the optical port 78 at different angles to produce respective output light beams 114, 116, which are output through the optical port 78 along different respective propagation directions in relation to the registration surface 80. In this way, the optical navigation sensor 110 is able to navigate optically with respect to transparent objects that have different thicknesses. For example, as shown in FIG. 7A, the optical navigation sensor 110 is able to navigate with respect to a transparent object of thickness t₃ using the output light beam 114, which is propagating at an incidence angle θ₃ in relation to the direction normal to the registration surface 80. As shown in FIG. 7B, the optical navigation sensor 110 is able to navigate with respect to a transparent object of thickness t₄<t₃ using the output light beam 106, which is propagating at an incidence angle θ₄>θ₃ in relation to the direction normal to the registration surface 80. The optical element 112 may be implemented by any type of actuatable optical device that is operable to direct the collimated light beam 74 along different respective propagation directions. In one exemplary embodiment, the optical component 112 is implemented by a mirror that pivots about an axis. The optical component 112 may be actuated automatically (e.g., by a motor) or manually. In this embodiment, the received interference beam 39 travels from the optical port 78 to the image sensor 14 along a beam path that is free of any interferometric elements.

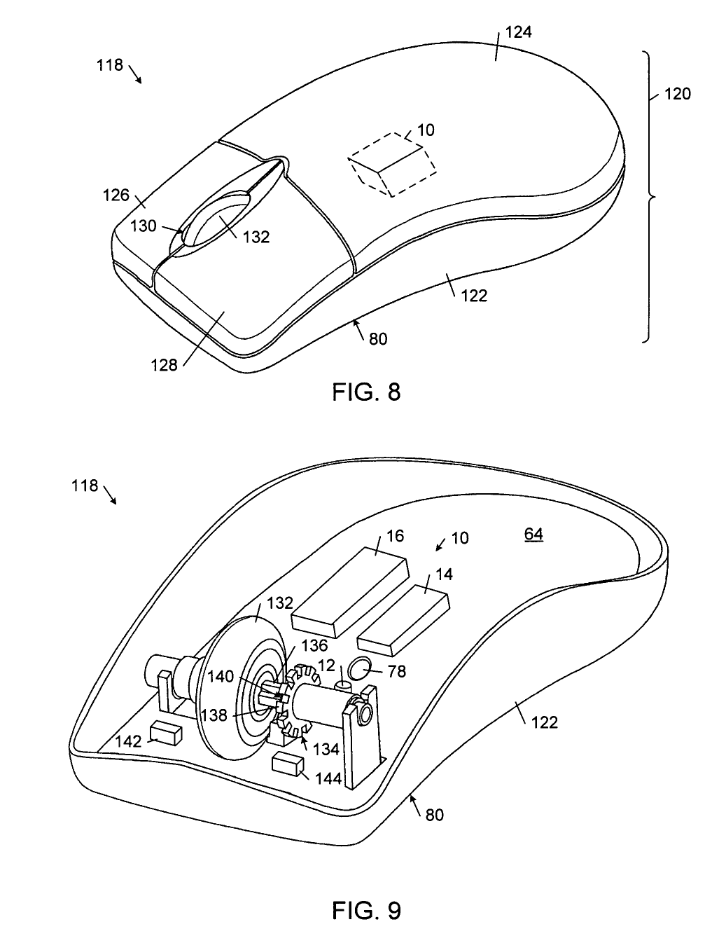

FIG. 8 shows a perspective view of an embodiment of an input device 118 that includes a housing 120 that contains an embodiment of the optical navigation sensor 10. The housing 120 includes a base 122 and a top portion 124. The housing 120 also includes a right input button 126, a left input button 128, and an opening 130 through a rotatable wheel 132 (e.g., a Z-axis control wheel or a Z-wheel) extends.

FIG. 9 is a perspective view of the input device 118 shown in FIG. 8 with the top portion 124 of the housing 120 removed to show the illumination system 12, the image sensor 14, and the processing system 16 of the optical navigation sensor 10. The rotatable wheel 132 and an optical encoder 134 are mounted on a shared rotatable shaft 136. The encoder 134 is implemented by a prior art code disk that includes a set of equally spaced teeth 138 and a set of slots 140 that are formed between adjacent ones of the teeth 138. In other embodiments, the encoder 134 is implemented by a translucent disk that includes a radially spaced pattern of grating lines. Right and left switches 142, 144 are used to detect when a user has activated the right and left input buttons 126, 128, respectively.

Other embodiments are within the scope of the claims.

What is claimed is:

1. An optical navigation system for determining movement in relation to an object having a front surface and a back surface and being substantially transparent to light within a wavelength range, the system comprising:
an illumination system operable to direct a beam of output light within the wavelength range toward the object so that a first portion of the output light beam reflects off the front surface to form a first reflected light beam and a second portion of the output light beam reflects off the back surface to form a second reflected light beam, wherein the first and second reflected light beams overlap in a region of space to produce an interference pattern;
an image sensor operable to capture images of the interference pattern; and
a processing system operable to produce motion signals indicative of movement of the image sensor in relation to the object from comparisons of ones of the images captured by the image sensor.

2. The system of claim 1, further comprising a housing containing the illumination system and the image sensor and comprising a registration surface, wherein the illumination system is oriented to direct the output light beam toward the object to produce the interference beam when the registration surface of the housing is facing the object.

3. The system of claim 2, wherein the housing comprises an optical port defined in the registration surface and the illumination system is operable to direct the output light beam through the optical port.

4. The system of claim 3, wherein the object is characterized by a specified refractive index n and a nominal thickness t between the front and back surfaces, and the illumination system outputs the output light beam from the optical port along a propagation direction at an output angle θ_{O} relative to a direction normal to the registration surface and with a lateral beam dimension w normal to the propagation direction such that
$$\frac{t}{w} < \frac{cos {θ}_{R}}{2 sin {θ}_{R} cos {θ}_{O}} , \\ wherein {θ}_{R} = {sin}^{- 1} ( \frac{sin {θ}_{O}}{n} ) .$$

5. The system of claim 3, wherein the illumination system comprises a beam splitter operable to direct the output light beam through the optical port along a propagation direction normal to the registration surface, to receive the light reflected from the object through the optical port, and to pass at least a portion of the reflected light to the image sensor.

6. The system of claim 3, wherein the illumination system is operable to direct toward the object output light beams in different respective propagation directions.

7. The system of claim 6, wherein the illumination system comprises a light source operable to generate a source light beam and an optical element operable to divide the source light beam into portions corresponding to the output light beams.

8. The system of claim 7, wherein the optical element comprises a diffractive optical element configured to divide the source light beam into the output light beams.

9. The system of claim 6, wherein the illumination system comprises a light source operable to generate a source light beam and an actuatable optical element operable to direct the source light beam through the optical port along each of the different propagation directions to produce the output light beams.

10. The system of claim 1, further comprising an optical port that receives the light reflected by the front surface of the object, wherein the reflected light travels from the optical port to the image sensor along a beam path free of any interferometric elements.

11. The system of claim 1, wherein the processing system is operable to produce user interface control signals from the motion signals.

12. The system of claim 1, further comprising a computer coupled to the processing system and operable to control a graphical user interface in response to the user interface control signals.

13. An optical navigation method for determining movement in relation to an object having a front surface and a back surface and being substantially transparent to light within a wavelength range, the method comprising:
directing a beam of output light within the wavelength range toward the object;
reflecting a first portion of the output light beam off the front surface to form a first reflected light beam;
reflecting a second portion of the output light beam passing through the object off the back surface to form a second reflected light beam passing out the front surface;
overlapping the first and second reflected light beams to produce an interference pattern;
capturing images of the interference pattern; and
producing motion signals indicative of movement in relation to the object from comparisons of ones of the captured images.

14. The method of claim 13, wherein the object is characterized by a specified refractive index n and a nominal thickness t between the front and back surfaces, and the directing comprises directing the output light beam along a propagation direction at an output angle θ_{O} relative to the front surface and with a lateral beam dimension w normal to the propagation direction such that
$$\frac{t}{w} < \frac{cos {θ}_{R}}{2 sin {θ}_{R} cos {θ}_{O}} , \\ wherein {θ}_{R} = {sin}^{- 1} ( \frac{sin {θ}_{O}}{n} ) .$$

15. The method of claim 13, wherein the directing comprises directing the output light beam along an outgoing propagation direction normal to the front surface, and the capturing comprises receiving the interference beam along an incoming propagation direction substantially parallel to the outgoing propagation direction.

16. The method of claim 13, wherein the directing comprises directing output light beams toward the object in different respective propagation directions.

17. The method of claim 16, wherein the directing comprises generating a source light beam and dividing the source light beam into portions corresponding to respective ones of the output light beams.

18. The method of claim 16, wherein the directing comprises generating a source light beam and directing the source light beam in each of the different propagation directions to produce the output light beams.

19. The method of claim 13, wherein during the capturing the light reflected from the object travels along a beam path free of any interferometric elements.

20. The method of claim 13, further comprising producing user interface control signals from the motion signals.
